(19) United States
(12) Patent Application Publication
(10) Pub. No.: US 2019/0155883 A1
(43) Pub. Date: May 23, 2019

(54) APPARATUS, METHOD AND COMPUTER PROGRAM PRODUCT FOR RECOVERING EDITABLE SLIDE

(71) Applicant: Nokia Technologies Oy, Espoo (FI)

(72) Inventor: Meng Wang, Nanjing, Jiangsu (CN)

(21) Appl. No.: 16/300,226

(22) PCT Filed: May 18, 2016
(86) PCT No.: PCT/CN2016/082457

§ 371 Date: Nov. 9, 2018

(51) Int. Cl. G06F 17/24; G06F 17/27; G06K 9/32; G06K 9/46

(52) U.S. Cl. CPC G06F 17/24; G06K 9/4633; G06K 9/325; G06F 17/2765

(57) ABSTRACT

Apparatus, method, computer program product and computer readable medium are disclosed for recovering an editable slide. The apparatus comprises at least one processor; at least one memory including computer program code, the memory and the computer program code configured to, working with the at least one processor, cause the apparatus to extract a slide area from image or video information associated with slide, wherein the slide comprises text and non-text information (201); segment the slide area into a plurality of regions (202); classify each of the plurality of regions into a text region or a non-text region (203); perform text recognition on the text region to obtain text information when a region is classified as the text region (204); and construct an editable slide with the non-text region or the text information according to their locations in the slide area (205).

### FIELD OF THE INVENTION

Embodiments of the disclosure generally relate to information technologies, and, more particularly, to recovering editable slide.

### BACKGROUND

The fast development of networks and electronic devices has dramatically changed the way of information acquisition and use. Nowadays, many people usually record slide presentation with videos or images using a video or image recorder such as mobile phones, cameras, video cameras or the like when they are attending a business or an academic conference. In addition, there are a lot of information associated with slide such as lecture videos or images on the web.

Currently there may be two approaches that may convert a video associated with slide to slides. The first approach is to extract only pictures. That means, the converted slides are merely a series of pictures, and the pictures can be displayed one by one. The second approach is to further perform Optical Character Recognition (OCR) and thus text contents are expected to be recovered. So, the two approaches recover pure pictures and pure texts, respectively. However, a typical slide may comprise text information and non-text information such as pictures, which are usually mixed and associated with animation. This kind of slide cannot be recovered by the above two approaches. Therefore, it is desirable to provide a technical solution for recovering an editable slide from image or video information associated with slide.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to one aspect of the disclosure, it is provided an apparatus. The apparatus may comprise at least one processor; at least one memory including computer program code, the memory and the computer program code configured to, working with the at least one processor, cause the apparatus to perform at least the following: extract a slide area from image or video information associated with slide, wherein the slide comprises text and non-text information; segmenting the slide area into a plurality of regions; classify each of the plurality of regions into a text region or a non-text region; perform text recognition on the text region to obtain text information when a region is classified as the text region; and construct an editable slide with the non-text region or the text information according to their locations in the slide area.

According to another aspect of the present disclosure, it is provided a method. The method may comprise extracting a slide area from image or video information associated with slide, wherein the slide comprises text and non-text information; segmenting the slide area into a plurality of regions; classifying each of the plurality of regions into a text region or a non-text region; performing text recognition on the text region to obtain text information when a region is classified as the text region; and constructing an editable slide with the non-text region or the text information according to their locations in the slide area.

According to still another aspect of the present disclosure, it is provided a computer program product embodied on a distribution medium readable by a computer and comprising program instructions which, when loaded into a computer, execute at least the following: extract a slide area from image or video information associated with slide, wherein the slide comprises text and non-text information; segmenting the slide area into a plurality of regions; classify each of the plurality of regions into a text region or a non-text region; perform text recognition on the text region to obtain text information when a region is classified as the text region; and construct an editable slide with the non-text region or the text information according to their locations in the slide area.

According to still another aspect of the present disclosure, it is provided a non-transitory computer readable medium having encoded thereon statements and instructions to cause a processor to execute at least the following: extract a slide area from image or video information associated with slide, wherein the slide comprises text and non-text information; segmenting the slide area into a plurality of regions; classify each of the plurality of regions into a text region or a non-text region; perform text recognition on the text region to obtain text information when a region is classified as the text region; and construct an editable slide with the non-text region or the text information according to their locations in the slide area.

According to still another aspect of the present disclosure, it is provided an apparatus comprising means configured to carry out at least the following: extract a slide area from image or video information associated with slide, wherein the slide comprises text and non-text information; segmenting the slide area into a plurality of regions; classify each of the plurality of regions into a text region or a non-text region; perform text recognition on the text region to obtain text information when a region is classified as the text region; and construct an editable slide with the non-text region or the text information according to their locations in the slide area.

These and other objects, features and advantages of the disclosure will become apparent from the following detailed description of illustrative embodiments thereof, which is to be read in connection with the accompanying drawings.

### BRIEF DESCRIPTION OF THE DRAWINGS

FIG. 1 is a simplified block diagram showing an apparatus according to an embodiment;

FIG. 2 is a flow chart depicting a process of recovering an editable slide in accordance with embodiments of the present disclosure;

FIG. 3 schematically shows a frame of a video that records a slide presentation;

FIG. 4 shows a schematic diagram of bottom-up approaches according to an embodiment;

FIG. 5 shows a schematic diagram of an OCR neural network for text recognition;

FIG. 6 is a flow chart depicting a process of recovering an editable slide in accordance with embodiments of the present disclosure;

FIG. 7 shows a schematic diagram of slide area alignment according to an embodiment;

FIG. 8 is a flow chart depicting a process of recovering an editable slide in accordance with embodiments of the present disclosure; and

FIG. 9 schematically shows motion vector examples for some animations according to an embodiment.

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement. Various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms should not be taken to limit the spirit and scope of embodiments of the present disclosure.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network apparatus, other network apparatus, and/or other computing apparatus.

As defined herein, a “non-transitory computer-readable medium,” which refers to a physical medium (e.g., volatile or non-volatile memory device), can be differentiated from a “transitory computer-readable medium,” which refers to an electromagnetic signal.

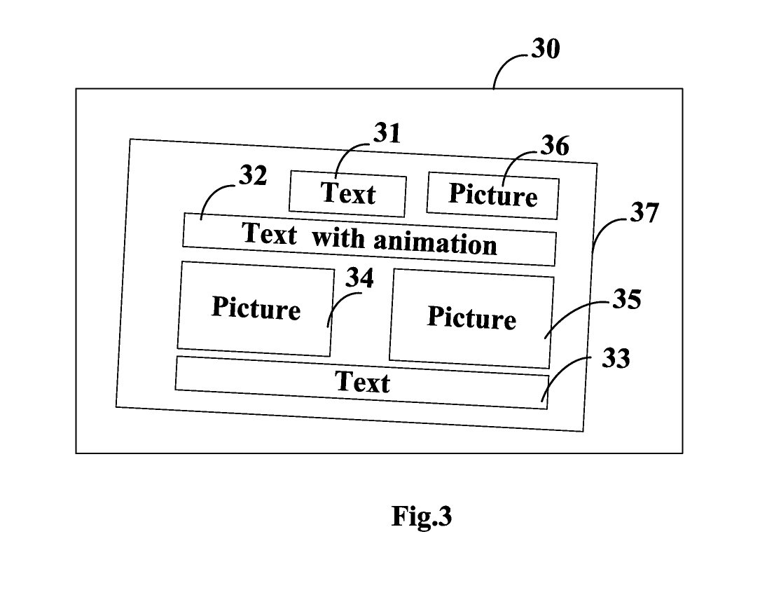

FIG. 3 schematically shows a frame of the video that records a slide presentation. As shown in FIG. 3, the frame 30 may contain at least a slide area 37. In another example, the frame 30 may further contain potential other objects (not shown in FIG. 3) such as a part of image of a speaker, a participator, or a light spot, which may locate in or outside the slide area 37. The slide area 37 may comprise text information such as texts 31, 32 and 33 and non-text information such as pictures 34, 35 and 36 and, which are usually mixed and associated with animation, for example the text 32 may fly in from left. In another example, the non-text information may further comprise other suitable information such as audio and video clip information (not shown in FIG. 3).

As mentioned above, the existing approaches only can recover pure pictures or pure texts. If a slide comprises pictures and texts which may be mixed, this kind of slide cannot be recovered by the existing approaches. In addition, it is noted that the slide area 37 may not be rectangle for example due to the video or image captured by a participator with a smart phone in his/her hand. In this case, the pure pictures or pure texts recovered by the existing approaches may not be properly aligned. Moreover, if the pictures and texts may be associated with animation, the existing approaches also cannot recover animation. Therefore, it is desirable to provide a technical solution for recovering an editable slide (such as in .ppt or .pptx format) from such video or image, which may potentially be used in much more scenarios.

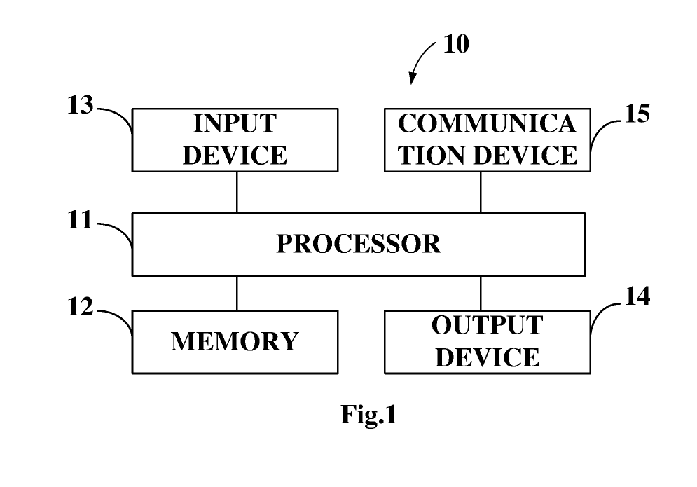

FIG. 1 is a simplified block diagram showing an apparatus, such as an electronic apparatus 10, in which various embodiments of the disclosure may be applied. It should be understood, however, that the electronic apparatus as illustrated and hereinafter described is merely illustrative of an apparatus that could benefit from embodiments of the disclosure and, therefore, should not be taken to limit the scope of the disclosure. While the electronic apparatus 10 is illustrated and will be hereinafter described for purposes of example, other types of apparatuses may readily employ embodiments of the disclosure. The electronic apparatus 10 may be a portable digital assistant (PDAs), a user equipment, a mobile computer, a desktop computer, a television, a gaming apparatus, a laptop computer, a media player, a camera, a video recorder, a mobile phone, a global positioning system (GPS) apparatus, a smart phone, a tablet, a laptop, a server, a thin client, a cloud computer, a virtual server, a set-top box, a computing device, a distributed system and/or any other types of electronic systems. The electronic apparatus 10 may run with any kind of operating system including, but not limited to, Windows, Linux, UNIX, Android, iOS and their variants. Moreover, the apparatus of at least one example embodiment need not to be the entire electronic apparatus, but may be a component or group of components of the electronic apparatus in other example embodiments.

Furthermore, the electronic apparatus may readily employ embodiments of the disclosure regardless of their intent to provide mobility. In this regard, even though embodiments of the disclosure may be described in conjunction with mobile applications, it should be understood that embodiments of the disclosure may be utilized in conjunction with a variety of other applications, both in the mobile communications industries and outside of the mobile communications industries.

In at least one example embodiment, the electronic apparatus 10 may comprise processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), and/or the like.

Processor 11 may comprise means, such as circuitry, for implementing audio, video, communication, navigation, logic functions, and/or the like, as well as for implementing embodiments of the disclosure including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 11 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise an output device 14. Output device 14 may comprise an audio output device, such as a ringer, an earphone, a speaker, and/or the like. Output device 14 may comprise a tactile output device, such as a vibration transducer, an electronically deformable surface, an electronically deformable structure, and/or the like. Output Device 14 may comprise a visual output device, such as a display, a light, and/or the like. The electronic apparatus may comprise an input device 13. Input device 13 may comprise a light sensor, a proximity sensor, a microphone, a touch sensor, a force sensor, a button, a keypad, a motion sensor, a magnetic field sensor, a camera, a removable storage device and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. Any keys may be physical keys in which, for example, an electrical connection is physically made or broken, or may be virtual. Virtual keys may be, for example, graphical representations on a touch sensitive surface, whereby the key is actuated by performing a hover or touch gesture on or near the surface. In addition, or alternatively, the electronic apparatus 10 may comprise an interface device such as a joystick or other user input interface.

Input device 13 may comprise a media capturing element. The media capturing element may be any means for capturing an image, video, and/or audio for storage, display or transmission. For example, in at least one example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In at least one example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format, a moving picture expert group (MPEG) standard format, a Video Coding Experts Group (VCEG) standard format or any other suitable standard formats.

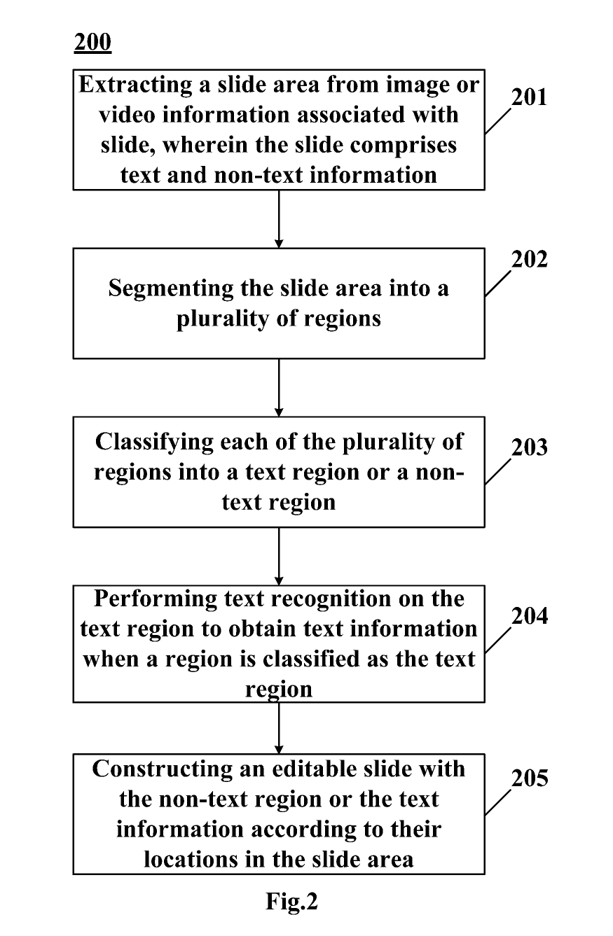

FIG. 2 is a flow chart depicting a process 200 of recovering an editable slide in accordance with embodiments of the present disclosure, which may be performed at an apparatus such as the electronic apparatus 10 of FIG. 1. As such, the electronic apparatus 10 may provide means for accomplishing various parts of the process 200 as well as means for accomplishing other processes in conjunction with other components.

As shown in FIG. 2, the process 200 starts at block 201 where a slide area is extracted from image or video information associated with slide, wherein the slide comprises text and non-text information. The image or video information can be captured in real time or retrieved from a local or remote storage device. For example, when people are attending a business, a lecture, an academic meeting or any other suitable activities, they may record slide presentation with videos or images using smart phones and optionally share them with other people or upload them to a network location. In addition, a lot of videos or images containing slides may be stored on the web or in local storage device. The text information may include but not limit to character, symbol, hyperlink, table and/or punctuation. The non-text information may include but not limit to picture, image, photo, diagram, video, audio and/or animation. For example, the animation may include fly in from bottom, fly in from top, fade out, fade in and/or any other suitable existing and future animation forms. The slide area is an area covered by a slide on a video frame or an image.

By way of example, referring to FIG. 1, the processor 11 may obtain the image or video information from the memory 12 if the image or video information is stored in the memory 12; obtain the image or video information from the input device 13 such as from a removable storage device which has stored the image or video information or from a camera; or obtain the image or video information from a network location by means of the communication device 15.

In general, except the animation, video or the like, the slide area may be static during the presentation. So, a “slide extractor” may be trained using existing or future object segmentation techniques to extract the slide area in a video frame or an image. For example, the following techniques can be used for extracting the slide area: Navneet Dalal, Bill Triggs, “Histograms of Oriented Gradients for Human Detection”, In IEEE conference on CVPR 2005, and US patent: U.S. Pat. No. 7,853,072B2, the disclosure of which are incorporated by reference herein in its entirety.

It is noted that in this embodiment the slide area may be a fixed size rectangle, for example, the image or video information may be captured by a fixed video or image recorder operated by a professional. In another embodiment, the slide area may not be the fixed size rectangle or may be other shapes such as a rhombus because the image or video information may be captured by a smart phone in a user's hand. In another embodiment, the target user of the editable slide generated by embodiments of the disclosure does not care whether the editable slide is the fixed size rectangle or not.

After extracting the slide area, the process 200 may proceed to block 202. At step 202, the slide area may be segmented into a plurality of regions. The region segmentation may be performed by any suitable existing or future region segmentation techniques such as top-down approaches: Seong-Whan Lee; Dae-Seok Ryu (2001). “Parameter-free geometric document layout analysis”, IEEE Transactions on Pattern Analysis and Machine Intelligence 23 (11): 1240-1256, or bottom-up approaches: O'Gorman, L., “The document spectrum for page layout analysis”, IEEE trans on Pattern Analysis and Machine Intelligence, 11(15): 1162-1173, November 1993, the disclosure of which are incorporated by reference herein in its entirety.

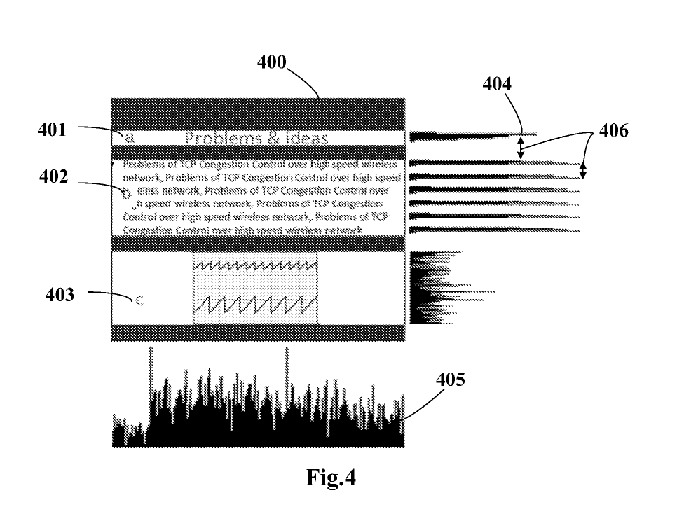

In an embodiment, the bottom-up approaches may be used to segment the slide into the plurality of regions. In the bottom-up approaches, the slide area may be split into different regions according to the horizontal and vertical projection histograms. FIG. 4 shows a schematic diagram of such approaches. As shown in FIG. 4, the slide region 400 includes two text regions 401 and 402 and a picture region 403, and the remaining region may be deemed as a background region. The horizontal and vertical projection histograms are indicated by 404 and 405 respectively. The slide region 400 could be cut into small regions in the direction with the bigger gap such as a gap 406 according to the horizontal projection histograms 404. For example, the two text regions 401 and 402 and the picture region 403 can be obtained in this way. In addition, the segmentation could be performed recursively to further cut the regions into smaller ones. By way of example, as shown in FIG. 3, the pictures 34 and 35 may be segmented as one region according to the horizontal projection histograms, and the one region can be further segmented into two regions such as picture 34 and 35 according to the vertical projection histograms. It is noted that the remaining region in the one region which excludes the picture 34 and 35 may be deemed as a background region, wherein the background region may be deemed as a non-text region.

In another embodiment, the slide may be segmented into the plurality of regions by a slide area segmentation approach. In this approach, the first step is salient point detection. Salient points may be defined as the points around which the patches are prominent for viewers. As noted by R. Hong, C. Wang, E Ge, M. Wang, and X. Wu, “Salience preserving multi focus image fusion,” in Proc. Int. Conf. Multimedia and Expo, 2009, pp. 1663-1666 and D. Marr, Vision. San Francisco, Calif.: Freeman, 1982, visual information extracted by an observer from visual stimulus is conveyed by changes perceived as gradients and edges. Therefore, salient points may be detected based on gradient map, which is computed following the below equations:

Gᵣ(i,j)={square root over ((R(i+1,j)−R(i,j))²+(R(i,j+1)−R(i,j))²)}

G_{g}(i,j)={square root over (G(i+1,j)−G(i,j))²+(G(i,j+1)−G(i,j))²)}

G_{b}(i,j)={square root over ((B(i+1,j)−B(i,j))²+(B(i,j+1)−B(i,j))²)}

G(i,j)=Gᵣ(i,j)+G_{g}(i,j)+G_{b}(i,j)

where R(i, j), G(i, j), and B(i, j) denote R(red), G(green) and B(blue) values at (i,j)-th position in an image. So, the salient point detection may be accomplished based on the following criterion: Point (i, j) is salient if G(i, j)>T, where T is a pre-defined threshold.

After obtaining the salient points, a subsequent step can be implemented following the approach described in Section III-B of the paper: Meng Wang, Yelong Sheng, Bo Liu, Xian-Sheng Hua, “In-Image Accessibility Indication,” IEEE Transactions on Multimedia, vol. 12, no. 4, pp. 330-336, 2010, the disclosure of which is incorporated by reference herein in its entirety. Following the approach, a set of regions can be generated, which may contain non-text (such as picture) or text information. In some cases, the set of regions may not fully cover the whole slide area, and the rest part can be regarded as a background region, wherein the background region may be deemed as a non-text region.

After segmenting the slide area into the plurality of regions, the process 200 may proceed to block 203. At step 203, each of the plurality of regions may be classified into a text region or a non-text region. The classification may be performed by any suitable existing or future region classification techniques. In an embodiment, a heuristic classification method may is performed to class each region into a text region or a non-text region, which is described in the reference document: Shih F Y, Chen S S, “Adaptive document block segmentation and classification,” IEEE Trans on Syst Man Cybern B Cyber, 26(5):797-802, 1996, the disclosure of which is incorporated by reference herein in its entirety. Many attributions of a region, such as the width and height, the number of black pixels, mean height are measured and the classification is performed by several predefined rules as described in this reference document. The non-text region may be directly used in constructing an editable slide, and the text region may be processed by block 204.

At block 204, text recognition may be performed on the text region to obtain text information when a region is classified as the text region. In an embodiment, the text recognition may be performed by OCR. For example, character, symbol, hyperlink, table, punctuation, etc and the size, location, color, font, format or the like thereof can be recognized by OCR. In other embodiments, the text recognition may be performed by any other suitable existing or future text recognition approaches.

In an embodiment, the OCR may be run by a model-based approach, wherein the model-based approach is described in the reference document, Tao Wang, David J. Wu, Adam Coates, and Andrew E Ng, “End-to-End Text Recognition with Convolutional Neural Networks,” In International Conference on Pattern Recognition (ICPR), 2012, the disclosure of which is incorporated by reference herein in its entirety.

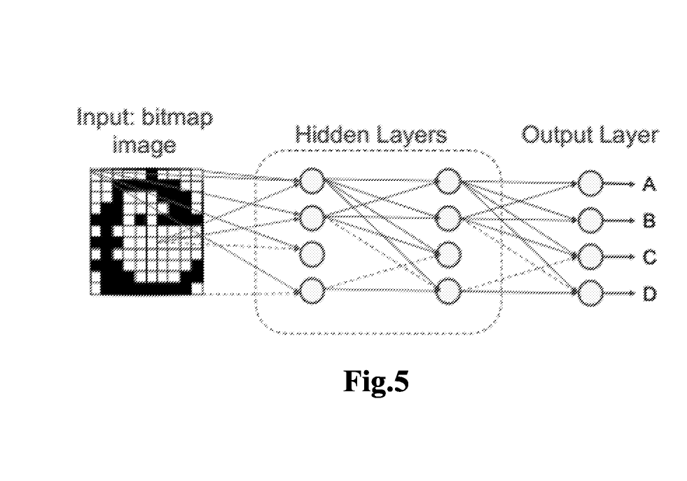

FIG. 5 shows a schematic diagram of an OCR neural network for text recognition. As shown in FIG. 5, a convolutional neural network is pre-trained by the labeled data, each character level region may be used as the network input, and the character may be predicted by the network.

At block 205, an editable slide may be constructed with the non-text region or the text information according to their locations in the slide area. For example, when characters are recognized, they could be reconstructed into words and/or sentences according to their locations in the text region, and subsequently the words and/or sentences may be put into the slide area according to the text region's location in the slide area. For the non-text region, it can be directly put into the slide area according to its location in the slide area. Therefore, the editable slide can be constructed with the non-text region or the text information according to their locations in the slide area. It is noted that the editable slide can be constructed after the text recognition has been performed on all the text regions in the slide area, or be gradually constructed after a non-text region has been classified or the text recognition has been performed on a text region.

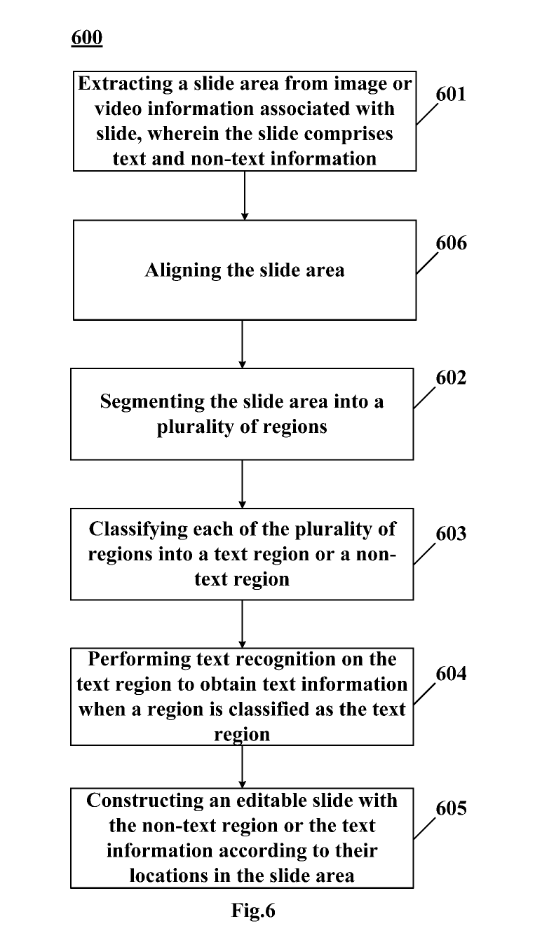

In some cases, the slide area, such as slide area 37 shown in FIG. 1, may not be a fixed size rectangle for example due to the video captured by a participator with his/her smart phone. In this case, the above mentioned operations performed on the unaligned slide area may not obtain good outputs whereby resulting in poor performance, or requiring more complicated technologies which may lead to more computing resources requirement or more time consumption. In addition, the user's experience may degrade. To address this issue, another embodiment of the disclosure may provide the slide area alignment which will be described with reference to FIG. 6.

FIG. 6 is a flow chart depicting a process 600 of recovering an editable slide in accordance with embodiments of the present disclosure, which may be performed at an apparatus such as the electronic apparatus 10 of FIG. 1. As such, the electronic apparatus may provide means for accomplishing various parts of the process 600 as well as means for accomplishing other processes in conjunction with other components. It is noted that blocks 601, 602, 603, 604 and 605 shown in FIG. 6 are similar to blocks 201, 202, 203, 204 and 205 shown in FIG. 2 which have been described above, and the description of these blocks is omitted here for brevity.

As shown in FIG. 6, the process 600 starts at block 601 where a slide area is extracted from image or video information associated with slide, wherein the slide comprises text and non-text information.

It is noted that in this embodiment the slide area may not be rectangle and/or the size of the slide area may change. For example, the image or video information may be captured by a smart phone in a user's hand. In this case, the slide area may not be rectangle. As another example, when the image or video information is taken from an incline angle, the slide area may not be rectangle. In addition, the projected image may also not be rectangle which may result in the slide area may not be rectangle. Moreover, the size of the slide area may change. For example, when the user takes the image or video information by his/her smart phone, he/she may zoom in and out on a target object such as the slide area, which may result in the change of the size of the slide area. There may be other factors that may result in that the slide area may not be rectangle and/or the size of the slide area may change. In these cases, the slide area extracted at block 601 should be aligned at block 606. The alignment of the slide area can be performed by any suitable existing and future alignment approaches.

In an embodiment, at block 606, alignment of the slide area may comprise detecting a quadrilateral of the slide area by Hough transform method; and performing the affine transformation on the slide area. For example, the quadrilateral of slide area can be detected firstly by Hough transform method, and then the affine transformation is performed on the slide area when fixing two end points in a diagonal line and moving the other two end points in another diagonal line accordingly. Through these operations, all the slide areas may be transformed to the same shapes with same size, such as the fixed size rectangle.

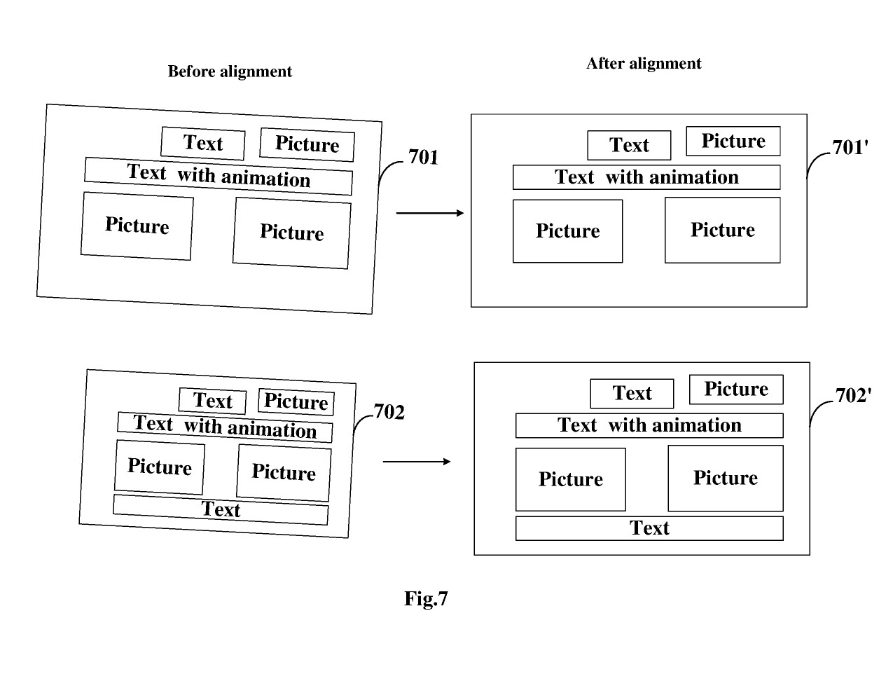

FIG. 7 shows a schematic diagram of slide area alignment according to an embodiment. As shown in FIG. 7, two slide areas 701 and 702 extracted at block 601 are shown in the left, and two slide areas 701′ and 702′ aligned at block 606 are shown in the right. It can be seen that two slide areas 701′ and 702′ are the same size rectangles. In this way, it can provide the same size and shape of slide areas which may improve efficiency and accuracy of the following operations as shown in blocks 602, 603, 604 and 605, thereby providing higher user experience.

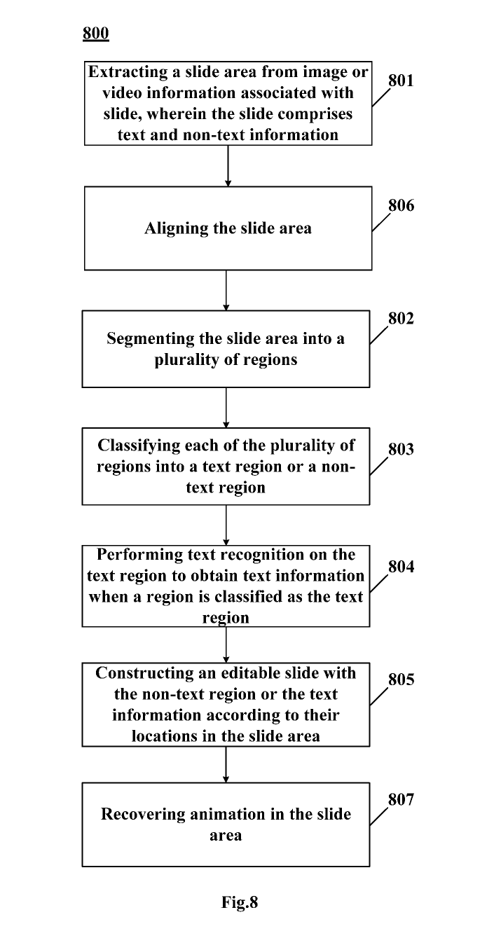

In most cases, the slide area may contain animation, for example, pictures and texts associated with animation or the like. The animation may be any suitable types of animation, such as fly in from left, fly in from bottom, fade out, fade in or the like. To recover the animation, another embodiment of the disclosure provides animation recovery approach which will be described with reference to FIG. 8.

FIG. 8 is a flow chart depicting a process 800 of recovering an editable slide in accordance with embodiments of the present disclosure, which may be performed at an apparatus such as the electronic apparatus 10 of FIG. 1. As such, the electronic apparatus may provide means for accomplishing various parts of the process 800 as well as means for accomplishing other processes in conjunction with other components. It is noted that blocks 801, 802, 803, 804, 806 and 806 shown in FIG. 8 are similar to blocks 601, 602, 603, 604, 605 and 606 shown in FIG. 6 which have been described above, and the description of these blocks is omitted here for brevity.

As shown in FIG. 8, after constructing an editable slide at block 805, the animation may be recovered in the slide area at block 807. It is noted that the animation recovery approach may be performed at a different stage in other embodiments, such as after block 802, 803 or 804. The animation recovery approach may be any suitable existing or future animation recovery approaches.

In an embodiment, recovery of the animation comprises: recognizing the animation by a set of classifiers; and recovering the animation. The set of classifiers may be animation recognizers. For example, an animation recognizer may recognize the animation of fly in from right, and another animation recognizer may recognize the animation of fade in, etc.

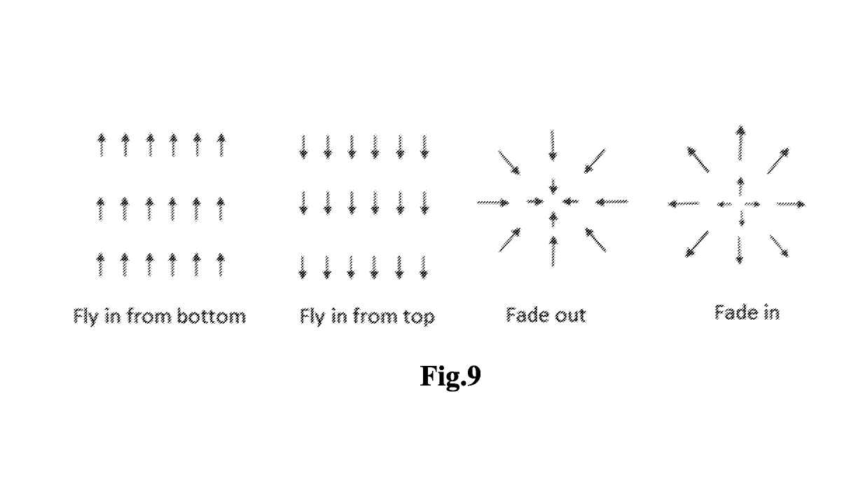

In an embodiment, the set of classifiers may be obtained by building a training set, wherein samples are video clips describing labeled animation and the video clips capture the variation of a non-text or a text, wherein the video clips video information are associated with slide; extracting visual features from the video clips; and training a set of classifiers based on the visual features, wherein one of the set of classifiers is able to classifier the variation of the picture or the text into a type of animation. Specifically, a training set may be built, in which a sample may be a video clip describing a labeled animation, such as “flying in from top”, “flying in from bottom”, “fade in”, or “fade out”. The video clip actually captures the variation of a picture, a set of words or other objects. Visual features may be extracted from the training video clips and then used to train a set of classifiers, which may classify the variation of each region into a type of animation. For example, motion vectors, as described in Lu, Jianhua; Liou, Ming, “A Simple and Efficient Search Algorithm for Block-Matching Motion Estimation”, IEEE Trans. Circuits and Systems For Video Technology 7 (2): 429-433, 1997, can be a set of features for distinguishing the animations, the disclosure of which is incorporated by reference herein in its entirety. FIG. 9 shows motion vector examples for some animations according to an embodiment. But other features widely used in video analysis can also be further integrated. The training of classifiers or animation recognizers may be an offline process. After obtaining the classifiers or animation recognizers, for the regions obtained in the previous step, the variation of each region can be tracked and the animation can be recognized. So, the animation can be recovered accordingly.

According to an aspect of the disclosure it is provided an apparatus for recovering an editable slide. For same parts as in the previous embodiments, the description thereof may be omitted as appropriate. The apparatus may comprise means configured to carry out the processes described above. In an embodiment, the apparatus comprises means configured to extract a slide area from image or video information associated with slide, wherein the slide comprises text and non-text information; means configured to segment the slide area into a plurality of regions; means configured to classify each of the plurality of regions into a text region or a non-text region; means configured to performing text recognition on the text region to obtain text information when a region is classified as the text region; and means configured to construct an editable slide with the non-text region or the text information according to their locations in the slide area.

In an embodiment, the apparatus may further comprise means configured to align the slide area.

In an embodiment, the apparatus may further comprise means configured to detect a quadrilateral of the slide area by Hough transform method; and means configured to perform the affine transformation on the slide area.

In an embodiment, the apparatus may further comprise means configured to segment the slide area into a plurality of regions by a slide area segmentation approach.

In an embodiment, the apparatus may further comprise means configured to classify each of the plurality of regions into a text region or a non-text region by a heuristic classification method.

In an embodiment, the apparatus may further comprise means configured to perform optical character recognition on the text region by a model-based approach.

In an embodiment, the apparatus may further comprise means configured to recover animation in the slide area.

In an embodiment, recovery of the animation comprises: recognize the animation by a set of classifiers; and recover the animation.

In an embodiment, the set of classifiers are obtained by building a training set, wherein samples are video clips describing labeled animation and the video clips capture the variation of a non-text or a text, wherein the video clips video information are associated with slide; extracting visual features from the video clips; and training a set of classifiers based on the visual features, wherein one of the set of classifiers is able to classifier the variation of the picture or the text into a type of animation.

It is noted that any of the components of the apparatus described above can be implemented as hardware or software modules. In the case of software modules, they can be embodied on a tangible computer-readable recordable storage medium. All of the software modules (or any subset thereof) can be on the same medium, or each can be on a different medium, for example. The software modules can run, for example, on a hardware processor. The method steps can then be carried out using the distinct software modules, as described above, executing on a hardware processor.

Additionally, an aspect of the disclosure can make use of software running on a general purpose computer or workstation. Such an implementation might employ, for example, a processor, a memory, and an input/output interface formed, for example, by a display and a keyboard. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. The processor, memory, and input/output interface such as display and keyboard can be interconnected, for example, via bus as part of a data processing unit. Suitable interconnections, for example via bus, can also be provided to a network interface, such as a network card, which can be provided to interface with a computer network, and to a media interface, such as a diskette or CD-ROM drive, which can be provided to interface with media.

Accordingly, computer software including instructions or code for performing the methodologies of the disclosure, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

As noted, aspects of the disclosure may take the form of a computer program product embodied in a computer readable medium having computer readable program code embodied thereon. Also, any combination of computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the disclosure may be written in any combination of at least one programming language, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

The flowchart and block diagrams in the figures illustrate the architecture, functionality, and operation of possible implementations of apparatus, methods and computer program products according to various embodiments of the disclosure. In this regard, each block in the flowchart or block diagrams may represent a module, component, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein, two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical region (both visible and invisible), as several non-limiting and non-exhaustive examples.

In any case, it should be understood that the components illustrated in this disclosure may be implemented in various forms of hardware, software, or combinations thereof, for example, application specific integrated circuit(s) (ASICS), functional circuitry, an appropriately programmed general purpose digital computer with associated memory, and the like. Given the teachings of the disclosure provided herein, one of ordinary skill in the related art will be able to contemplate other implementations of the components of the disclosure.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

1-21. (canceled)

22. An apparatus, comprising:
at least one processor;
at least one memory including computer program code, the memory and the computer program code configured to, working with the at least one processor, cause the apparatus to perform at least the following:
extract a slide area from image or video information associated with slide, wherein the slide comprises text and non-text information;
segment the slide area into a plurality of regions;
classify each of the plurality of regions into a text region or a non-text region;
perform text recognition on the text region to obtain text information when a region is classified as the text region; and
construct an editable slide with the non-text region or the text information according to their locations in the slide area.

23. The apparatus according to claim 22, wherein the memory further comprises computer program code that causes the apparatus to align the slide area.

24. The apparatus according to claim 23, wherein alignment of the slide area comprises:
detect a quadrilateral of the slide area by Hough transform method; and
perform the affine transformation on the slide area.

25. The apparatus according to claim 22, wherein segment the slide area into a plurality of regions comprises segment the slide area into a plurality of regions by a slide area segmentation approach.

26. The apparatus according to claim 22, wherein classify each of the plurality of regions into a text region or a non-text region comprises classify each of the plurality of regions into a text region or a non-text region by a heuristic classification method.

27. The apparatus according to claim 22, wherein perform text recognition on the text region comprises perform optical character recognition on the text region by a model-based approach.

28. The apparatus according to claim 22, wherein the slide area is extracted from the video information, and the memory further comprises computer program code that causes the apparatus to recover animation in the slide area.

29. The apparatus according to claim 28, wherein recovery of the animation comprises:
recognize the animation by a set of classifiers; and
recover the animation.

30. The apparatus according to claim 29, wherein the set of classifiers are obtained by
building a training set, wherein samples are video clips describing labeled animation and the video clips capture the variation of a non-text or a text, wherein the video clips video information are associated with slide;
extracting visual features from the video clips; and
training a set of classifiers based on the visual features, wherein one of the set of classifiers is able to classifier the variation of the picture or the text into a type of animation.

31. A method, comprising:
extracting a slide area from image or video information associated with slide, wherein the slide comprises text and non-text information;
segmenting the slide area into a plurality of regions;
classifying each of the plurality of regions into a text region or a non-text region;
performing text recognition on the text region to obtain text information when a region is classified as the text region; and
constructing an editable slide with the non-text region or the text information according to their locations in the slide area.

32. The method according to claim 31, further comprising aligning the slide area.

33. The method according to claim 32, wherein alignment of the slide area comprises:
detecting a quadrilateral of the slide area by Hough transform method; and
performing the affine transformation on the slide area.

34. The method according to claim 31, wherein segmenting the slide area into a plurality of regions comprises segmenting the slide area into a plurality of regions by a slide area segmentation approach.

35. The method according to claim 31, wherein classifying each of the plurality of regions into a text region or a non-text region comprises classifying each of the plurality of regions into a text region or a non-text region by a heuristic classification method.

36. The method according to claim 31, wherein performing text recognition on the text region comprises performing optical character recognition on the text region by a model-based approach.

37. The method according to claim 31, wherein the slide area is extracted from the video information, and the method further comprises recovering animation in the slide area.

38. The method according to claim 37, wherein recovery of the animation comprises:
recognizing the animation by a set of classifiers; and
recovering the animation.

39. The method according to claim 38, wherein the set of classifiers are obtained by
building a training set, wherein samples are video clips describing labeled animation and the video clips capture the variation of a non-text or a text, wherein the video clips video information are associated with slide;
extracting visual features from the video clips; and
training a set of classifiers based on the visual features, wherein one of the set of classifiers is able to classifier the variation of the picture or the text into a type of animation.

40. A non-transitory computer readable medium having encoded thereon statements and instructions to cause a processor to execute a method according to any of the following:
extracting a slide area from image or video information associated with slide, wherein the slide comprises text and non-text information;
segmenting the slide area into a plurality of regions;
classifying each of the plurality of regions into a text region or a non-text region;
performing text recognition on the text region to obtain text information when a region is classified as the text region; and
constructing an editable slide with the non-text region or the text information according to their locations in the slide area.

41. The non-transitory computer readable medium according to claim 40, wherein classifying each of the plurality of regions into a text region or a non-text region comprises classifying each of the plurality of regions into a text region or a non-text region by a heuristic classification method.
